(19) United States
(12) Patent Application Publication
(10) Pub. No.: US 2014/0288906 A1
(43) Pub. Date: Sep. 25, 2014

(54) ANALYSIS DEVICE, ANALYSIS METHOD, ANALYSIS PROGRAM, AND RECORDING MEDIUM

(71) Applicant: JAPAN AGENCY FOR MARINE-EARTH SCIENCE AND TECHNOLOGY, Yokosuka-shi, Kanagawa (JP)

(72) Inventors: Hide Sakaguchi, Yokosuka-shi (JP); Daisuke Nishiura, Yokosuka-shi (JP)

(21) Appl. No.: 14/350,155

(22) PCT Filed: Oct. 15, 2012
(86) PCT No.: PCT/JP2012/076628

§ 371 Date: Apr. 7, 2014

(30) Foreign Application Priority Data
Oct. 17, 2011 (JP) 2011-228247

(51) Int. Cl. G06F 17/50

(52) U.S. Cl. CPC G06F 17/5009
USPC 703/2

(57) ABSTRACT

An analysis apparatus 10 is an apparatus for analyzing a motion of a deformable body and comprises a model generation unit 12 for generating a model of the deformable body provided with virtual particles whose centers constitute vertexes of a tetrahedron dividing the deformable body, a first force calculation unit 13 for calculating a first force occurring between the particles nonadjacent to each other provided on a surface of the deformable body, a second force calculation unit 14 for computing a stress occurring in the tetrahedron dividing the deformable body and calculating a second force occurring in each particle from a plane dividing the tetrahedron and the stress, and a particle position updating unit 15 for taking a sum of the first and second forces so as to compute a force occurring in each particle and solving a motion equation so as to update a position of each particle.

### TECHNICAL FIELD

The present invention relates to an analysis apparatus, analysis method, analysis program, and recording medium for analyzing a motion of at least one deformable body.

### BACKGROUND ART

Techniques such as discrete element method (DEM) have conventionally been known as methods for analyzing motions of objects (elements) which incur collisions and contacts. Also known are a method called discontinuous deformation analysis (DDA) which takes account of deformations of elements to be analyzed (see, for example, Patent Literature 1) and a method called QDEM (Quadraple Discrete Element Method; see, for example, Non Patent Literature 1).

### CITATION LIST

### Patent Literature

Patent Literature 1: Japanese Patent Application Laid-Open No. H07-181879

### Non Patent Literature

Hide Sakaguchi, “New computational scheme of discrete element approach for the solid earth multi-materials simulation using three-dimensional four particle interaction,” FRONTIER RESEARCH ON EARTH EVOLUTION, VOL. 2, (2004).

### SUMMARY OF INVENTION

### Technical Problem

The overall behavior of gravel, a wire, or a cable, which is an assembly of a number of stones or steel lines, is greatly affected by properties concerning deformations of individual stones and steel lines. However, it is not determined by the properties as the assembly or properties of the individual stones or steel lines alone. For example, the overall property greatly varies depending on how the stones are spread or in which form they are piled up in the case of gravel and how the steel lines are twisted in the case of wire or cable.

For such objects, appropriate analyses such as accurate simulations of motions accompanying elastic wave propagations or destructions within an element, for example, cannot be performed unless collisions and contacts between elements such as individual stones and steel lines and deformations of the individual elements themselves are both taken into consideration. Elements such as stones and steel lines have large contact pressures and frictional forces. That is, frictional forces and slip properties must specifically be taken into consideration for the above-mentioned contacts and collisions.

However, while taking account of deformations, the above-mentioned discontinuous deformation analysis has been problematic in that it will incur such an enormous calculation load as to necessitate a long calculation time if there are a large number of elements such as individual stones and steel lines, since it calculates the collisions and contacts after performing calculations for the deformations concerning the individual elements. Therefore, such objects have currently been evaluated only empirically. The DEM includes a method which models one deformable element by linking a plurality of spherical particles, but it cannot accurately analyze deformations in elements themselves and stresses therewithin, since there is no constitutive law for reproducing correct physical properties. The QDEM, which can analyze deformations of a single element and stresses therewithin according to a constitutive law, lacks methods for determining contacts and collisions between a plurality of elements and functions for calculating interaction forces and thus cannot analyze motions of a plurality of deformable elements, which are to be analyzed here.

In view of the problems mentioned above, it is an object of the present invention to provide an analysis apparatus, analysis method, analysis program, and recording medium which, even when there are a large number of deformable bodies (objects) as subject elements, can perform a high-speed analysis while taking account of not only collisions and contacts between the deformable bodies but also deformations of the deformable bodies themselves.

### Solution to Problem

For achieving the above-mentioned object, the analysis apparatus in accordance with one embodiment of the present invention is an analysis apparatus for analyzing a motion of at least one deformable body, the apparatus comprising model generation means for generating a model of the deformable body provided with a plurality of virtual particles whose centers constitute vertexes of a tetrahedron dividing the deformable body; first force calculation means for calculating a first force occurring between the particles nonadjacent to each other provided on a surface of the deformable body in the model generated by the model generation means; second force calculation means for computing a stress occurring in the tetrahedron dividing the deformable body in the model generated by the model generation means and determining a plane dividing the tetrahedron, so as to calculate a second force occurring in each of the particles constituting the tetrahedron from the computed stress; and particle position updating means for taking a sum of the first force calculated by the first force calculation means and the second force calculated by the second force calculation means for each particle, so as to compute a force occurring in each particle, and solving a motion equation according to the computed force, so as to update a position of each particle.

The analysis apparatus in accordance with one embodiment of the present invention calculates the first force concerning collisions and contacts between deformable bodies and the second force concerning deformations of the deformable bodies and updates the position of each particle according to a force of their sum. Virtual particles provided in deformable bodies are used for calculating both of the first and second forces. Therefore, the analysis apparatus in accordance with one embodiment of the present invention can compute both of the first and second forces by calculations for a common item constituted by the above-mentioned virtual particles. Hence, even when there are a large number of deformable bodies, the analysis apparatus in accordance with one embodiment of the present invention can perform a high-speed analysis while taking account of not only the collisions and contacts between the deformable bodies but also the deformations of the deformable bodies themselves.

The model generation means may generate the model of the deformable body by further arranging particles constituting the vertexes of the tetrahedron while in a preset positional relationship with the particles arranged according to the number of deformable bodies until a set termination condition is satisfied. This configuration can efficiently generate a model in which a regular, high-quality tetrahedron is provided for a number of deformable bodies.

The first force calculation means may calculate the first force according to the position of each particle and a preset parameter of the particle. The preset parameter may comprise the radius, mass, and spring constant of the particle. These configurations make it possible to calculate the first force appropriately and securely.

The second force calculation means may calculate the stress occurring in the tetrahedron dividing the deformable body according to a temporal positional change or velocity of each of the particles constituting the tetrahedron. This configuration makes it possible to calculate the second force appropriately and securely.

The present invention can be described not only as an invention of analysis apparatus as mentioned above but also as inventions of analysis method and analysis program as follows. They differ from each other only in categories and the like but are substantially the same invention and exhibit the same operations and effects.

The analysis method in accordance with one embodiment of the present invention is an analysis method by an analysis apparatus for analyzing a motion of at least one deformable body, the method comprising a model generation step of generating a model of the deformable body provided with a plurality of virtual particles whose centers constitute vertexes of a tetrahedron dividing the deformable body; a first force calculation step of calculating a first force occurring between the particles nonadjacent to each other provided on a surface of the deformable body in the model generated at the model generation step; a second force calculation step of computing a stress occurring in the tetrahedron dividing the deformable body in the model generated at the model generation step and determining a plane dividing the tetrahedron, so as to calculate a second force occurring in each of the particles constituting the tetrahedron from the computed stress; and a particle position updating step of taking a sum of the first force calculated at the first force calculation step and the second force calculated at the second force calculation step for each particle, so as to compute a force occurring in each particle, and solving a motion equation according to the computed force, so as to update a position of each particle.

The analysis program in accordance with one embodiment of the present invention is an analysis program for causing a computer to analyze a motion of at least one deformable body, the program making the computer function as model generation means for generating a model of the deformable body provided with a plurality of virtual particles whose centers constitute vertexes of a tetrahedron dividing the deformable body; first force calculation means for calculating a first force occurring between the particles nonadjacent to each other provided on a surface of the deformable body in the model generated by the model generation means; second force calculation means for computing a stress occurring in the tetrahedron dividing the deformable body in the model generated by the model generation means and determining a plane dividing the tetrahedron, so as to calculate a second force occurring in each of the particles constituting the tetrahedron from the computed stress; and particle position updating means for taking a sum of the first force calculated by the first force calculation means and the second force calculated by the second force calculation means for each particle, so as to compute a force occurring in each particle, and solving a motion equation according to the computed force, so as to update a position of each particle.

The recording medium in accordance with one embodiment of the present invention is a computer-readable recording medium recording an analysis program for causing a computer to analyze a motion of at least one deformable body, the program making the computer function as model generation means for generating a model of the deformable body provided with a plurality of virtual particles whose centers constitute vertexes of a tetrahedron dividing the deformable body; first force calculation means for calculating a first force occurring between the particles nonadjacent to each other provided on a surface of the deformable body in the model generated by the model generation means; second force calculation means for computing a stress occurring in the tetrahedron dividing the deformable body in the model generated by the model generation means and determining a plane dividing the tetrahedron, so as to calculate a second force occurring in each of the particles constituting the tetrahedron from the computed stress; and particle position updating means for taking a sum of the first force calculated by the first force calculation means and the second force calculated by the second force calculation means for each particle, so as to compute a force occurring in each particle, and solving a motion equation according to the computed force, so as to update a position of each particle.

### Advantageous Effects of Invention

In the present invention, both of the first force concerning collisions and contacts between deformable bodies and the second force concerning deformations of the deformable bodies can be computed by calculations for a common item constituted by virtual particles. Hence, even when there are a large number of deformable bodies, the present invention can perform a high-speed analysis while taking account of not only the collisions and contacts between the deformable bodies but also the deformations of the deformable bodies themselves.

### BRIEF DESCRIPTION OF DRAWINGS

FIG. 1 is a diagram illustrating a functional structure of the analysis apparatus in accordance with an embodiment of the present invention;

FIG. 2 is a diagram for explaining how to generate a model used for an analysis, illustrating a basic unit of a face-centered cubic lattice;

FIG. 3 is a diagram illustrating a tetrahedron generated in a basic unit;

FIG. 4 is a set of diagrams illustrating a (void of) a quadrangular pyramid generated in a basic unit;

FIG. 5 is a diagram illustrating an octahedron generated between basic units adjacent to each other;

FIG. 6 is a set of diagrams illustrating a tetrahedron generated in a basic unit and an octahedron constituted by the tetrahedron between basic units adjacent to each other;

FIG. 7 is a set of diagrams illustrating how to divide an octahedron;

FIG. 8 is a set of diagrams illustrating examples of directions in which particles grow;

FIG. 9 is a set of diagrams illustrating specific examples of model generations;

FIG. 10 is a set of diagrams for explaining elastic stress tensors concerning a tetrahedron;

FIG. 11 is a diagram for explaining viscous stress tensors concerning a tetrahedron;

FIG. 12 is a diagram for explaining how to calculate a force occurring in each particle from tensors generated in a tetrahedron;

FIG. 13 is a flowchart illustrating a process (analysis method) executed by the analysis apparatus in accordance with the embodiment of the present invention;

FIG. 14 is a set of diagrams illustrating examples of analysis results by the analysis apparatus in accordance with the embodiment of the present invention; and

FIG. 15 is a diagram illustrating the structure of the analysis program in accordance with the embodiment of the present invention together with a recording medium.

### DESCRIPTION OF EMBODIMENTS

In the following, embodiments of the present invention will be explained in detail with reference to the drawings. In the drawings, the same constituents will be referred to with the same signs while omitting their overlapping descriptions.

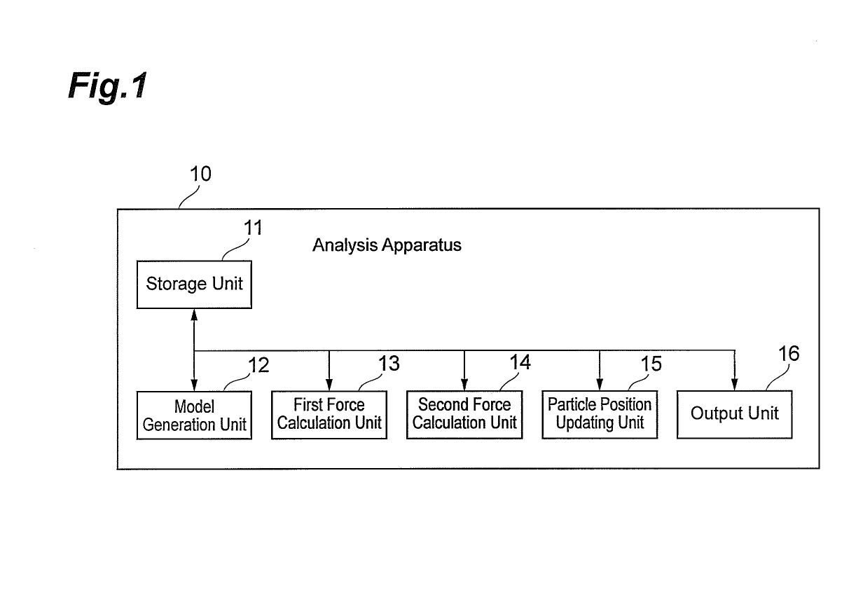

FIG. 1 illustrates an analysis apparatus 10 in accordance with an embodiment. The analysis apparatus 10 performs an analysis (simulation) of a motion of at least one deformable body. Examples of the deformable body include objects such as stones and steel lines. The deformable body may be either a solid (elastic body or viscoelastic body) or a viscous or viscoelastic fluid. The analysis apparatus 10 in accordance with this embodiment models the deformable body and calculates a position (e.g., in three-dimensional coordinates) of the deformable body at each time (moment) by the analysis. Here, contacts (collisions) between the deformable bodies or between different parts of one deformable body are taken into consideration. The fact that the deformable body is deformed by a force applied thereto is also taken into consideration.

The analysis apparatus 10 is constructed as a computer comprising hardware such as a CPU (Central Processing Unit), a GPU (Graphics Processing Unit), a memory, a hard disk, and a display, for example. These constituents are operated by a program and the like, so as to exhibit functions as the analysis apparatus 10 which will be explained later.

As FIG. 1 illustrates, the analysis unit 10 comprises a storage unit 11, a model generation unit 12, a first force calculation unit 13, a second force calculation unit 14, a particle position updating unit 15, and an output unit 16.

The storage unit 11 is a means for storing information necessary for the analysis by the analysis apparatus 10. The storage unit 11 prestores the information necessary as a parameter for the analysis. This information is inputted beforehand as a control file or the like into the analysis apparatus 10 by its user, for example. In the process of analysis, calculated information is inputted (written) into the storage unit 11 from individual constituents, which will be explained later, as required. The information stored in the storage unit 11 is referred to from the individual constituents (model generation unit 12, first force calculation unit 13, second force calculation unit 14, particle position updating unit 15, and output unit 16) as required. Which information the storage unit 11 stores will specifically be explained at the time when the information is utilized or calculated.

The model generation unit 12 is a model generation means for generating a model of the deformable body to be analyzed. The model generation unit 12 generates the model of the deformable body by providing (a region including) a three-dimensional deformable body with a plurality of virtual particles. The particles have respective centers which constitute vertexes of a tetrahedron dividing the deformable body. The analysis is performed by assuming that the above-mentioned deformable body exists in the region where the particles are located.

The model generation unit 12 may read information indicating the form and initial arrangement of the deformable body from the storage unit 11 and provide tetrahedrons with particles by an existing tetrahedral mesh automatic generation method, which is utilized by a finite element method (FEM) or the like, according to this information. That is, the tetrahedrons are sequentially determined by 1) attaching points generating a triangular polygon mesh to the surface of the deformable body, 2) generating a number of points keeping a number density on a par with that of triangular polygons in a space within the deformable body, and 3) numerically finding the minimum circumscribed sphere among adjacent four points.

At this time, the quality of each tetrahedron is controlled by making the length of ridges (sides) of the tetrahedron more uniform. By the quality of the tetrahedron herein are meant fluctuations in length of sides constituting a tetrahedron and sizes among tetrahedrons (the quality is better as the fluctuations are smaller), for example. As a procedure, a technique which performs micro-tetrahedralization while keeping the tetrahedron quality finding by a rougher tetrahedral mesh having a relatively uniform tetrahedral mesh and then stepwise subdividing the mesh of each tetrahedron may be used. A model is generated by providing particles whose centers are vertexes of the tetrahedron produced by the method mentioned above.

The model generation unit 12 may generate the model of the deformable body not only by the typical tetrahedral mesh generation method mentioned above, but also by the following method. That is, the model generation unit 12 may arrange virtual particles according to the number of deformable bodies and further (newly) arrange particles constituting the vertexes of tetrahedrons while in a preset positional relationship with the former particles until a set termination condition is satisfied. The model is generated in the following manner, for example.

The above-mentioned typical tetrahedral mesh generation method, which was originally created for tetrahedralizing one object or region, must be fed with an object form or region form as an input beforehand. It is therefore essentially unsuitable for automatically dividing individual objects into a number of tetrahedrons while automatically generating object groups when a number of objects are subjects or the individual objects further have irregular forms. When subjects for the analysis are a number of deformable bodies having irregular forms such as (a stone constituted by) a number of pieces of gravel, a method of automatically generating deformable bodies while tetrahedralizing the inside such as the following may be used, for example.

Hence, instead of tetrahedralizing the inside of deformable bodies, this technique uses a face-centered cubic lattice and two kinds of tetrahedrons included therewithin from points within the deformable bodies and grows them to forms of deformable bodies required for the analysis, thereby automatically generating regular, high-quality meshes for a number of objects.

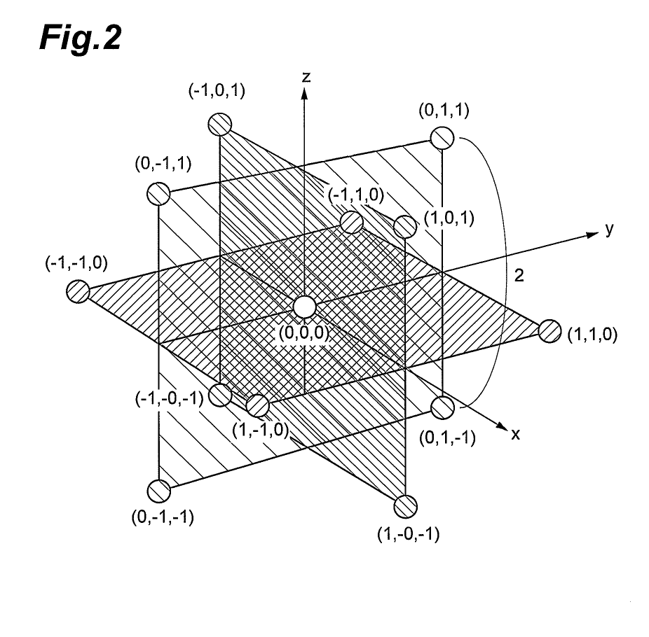

FIG. 2 illustrates a basic unit of a face-centered cubic lattice. An orthogonal coordinate system x-y-z whose origin is (0, 0, 0) indicated in the diagram is defined. Assume three squares each having a side length of 2 exist on the x-y plane (z=0), y-z plane (x=0), and z-x plane (y=0), respectively. Then, it is seen that all of the 12 vertexes (1, 1, 0), (−1, 1, 0), (−1, −1, 0), (1, −1, 0), (0, 1, 1), (0, −1, 1), (0, −1, −1), (0, 1, −1), (1, 0, 1), (−1, 0, 1), (−1, 0, −1), and (1, 0, −1) of the three squares are equally distanced at √2 from the origin. These 12 points and the origin constitute 13 points in total of lattice points of the basic unit of the face-centered cubic lattice.

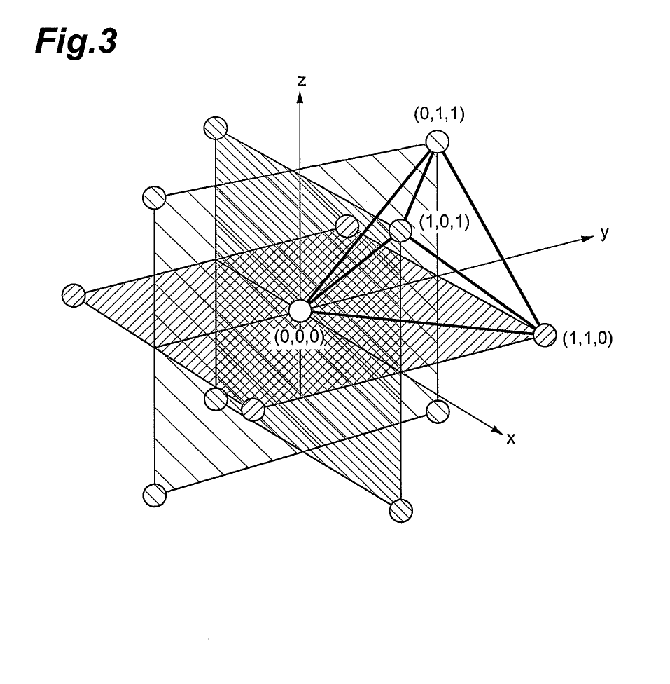

A tetrahedron produced by choosing four lattice points all having an adjacent lattice point distance of √2 is a regular tetrahedron constituted by four equilateral triangles each having a side length of √2 as illustrated in FIG. 3. When the front side (x>0) of the square on the y-z plane is concerned, four regular tetrahedrons congruent to the tetrahedron illustrated in FIG. 3 are produced. Similarly, four such tetrahedrons can be assumed on the rear side (x<0) of the square on the y-z plane, whereby eight regular tetrahedrons in total are seen to exist in this basic unit.

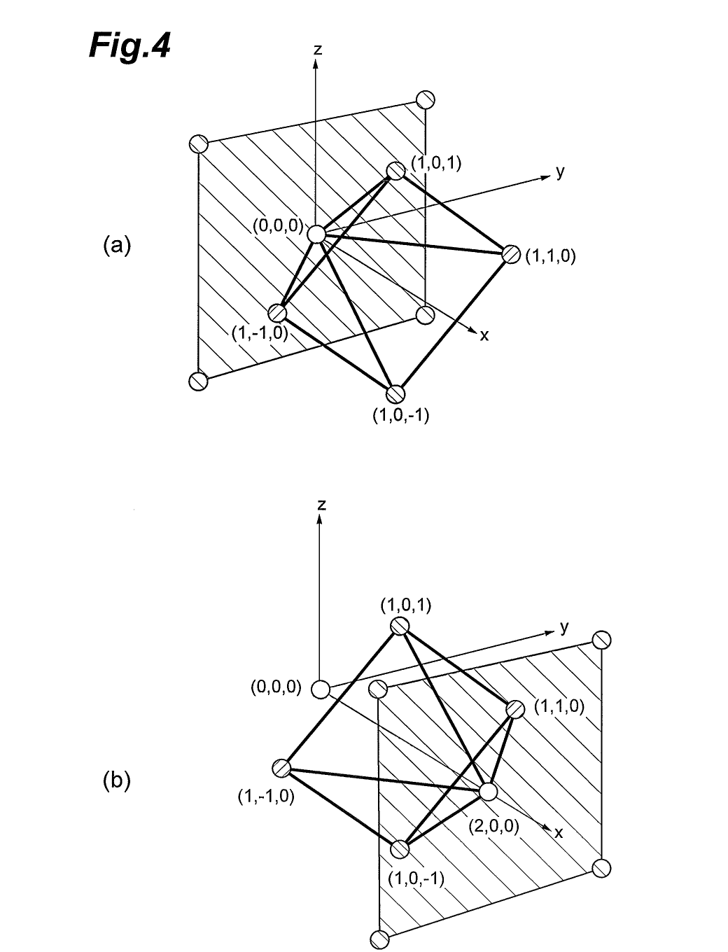

A quadrangular pyramid void having a height of 1 with a square bottom face having a side length of √2 is formed among the four regular tetrahedrons in a region on the front side (x>0) of the y-z plane produced by the above-mentioned method as illustrated in FIG. 4(a). Similarly, such quadrangular pyramid voids occur on the x<0 side, as well as the y>0 and y<0 sides of the z-x plane and the z>0 and z<0 sides of the x-y plane, i.e., in six directions in total. Such a quadrangular pyramid void as seen in FIG. 4(a) similarly occurs in all of the units adjacent to the face-centered cubic lattice centered at (0, 0, 0). For example, a quadrangular pyramid void illustrated in FIG. 4(b) occurs among the four regular tetrahedrons on the x<0 side of the y-z plane of the unit centered at (2, 0, 0).

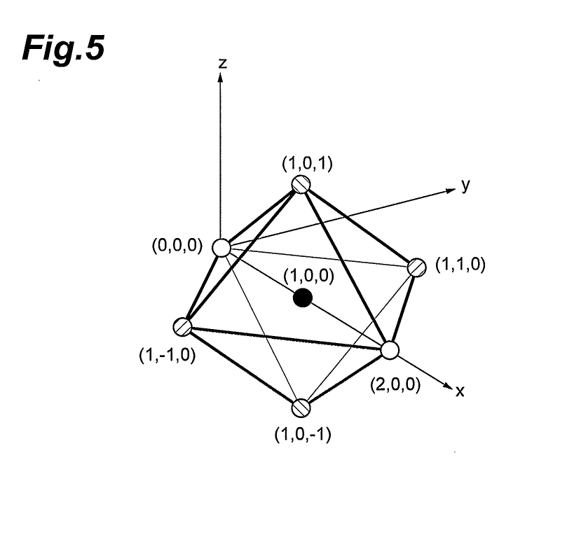

The voids illustrated in FIGS. 4(a) and 4(b) share the same square on their bottom faces, while a line segment (0, 0, 0)-(2, 0, 0) on the x axis connecting the vertexes of the two quadrangular pyramids perpendicularly intersects the square at the center of gravity. Then, the solid formed by combining the quadrangular pyramids illustrated in FIGS. 4(a) and 4(b) together becomes a regular octahedron composed of eight equilateral triangles each having a side length of √2 as illustrated in FIG. 5.

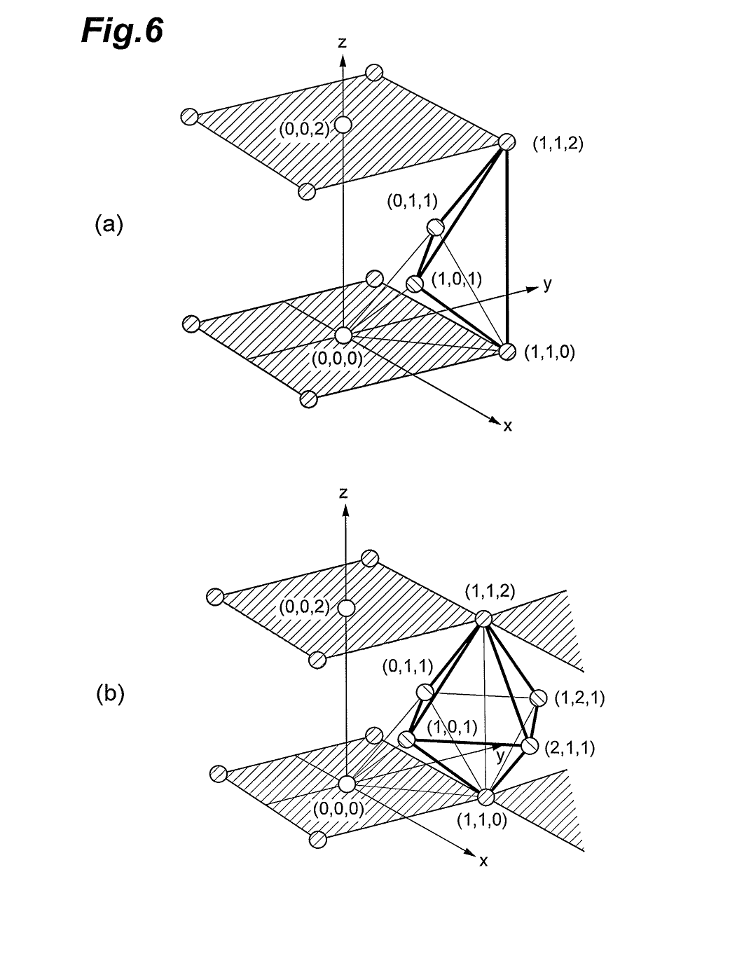

On the other hand, assuming that the regular tetrahedron illustrated in FIG. 3 has a vertex at the origin (0, 0, 0) and a bottom triangle at (1, 1, 0)-(0, 1, 1)-(1, 0, 1), a void also occurs in the unit of (0, 0, 0) in a space on the side opposite from the vertex in the bottom triangle. For completely filling this void, among the vertexes of the square on the x-y plane centered at (0, 0, 2), which is a unit adjacent in the z direction to the square on the x-y plane (z=0) illustrated in FIG. 3, a positional relationship between a point (1, 0, 1) and a point (1, 1, 2) located closest to (0, 1, 1) is considered. Then, a tetrahedral region constituted by four vertexes (1, 1, 2), (0, 1, 1), (1, 0, 1), and (1, 1, 0) as illustrated in FIG. 6(a) is formed there.

Similarly, tetrahedral regions occur in three adjacent units whose centers are at (2, 0, 0), (2, 2, 0), and (0, 2, 0) surrounding a line segment (1, 1, 0)-(1, 1, 2). It is seen that adding together all the tetrahedral regions sharing the line segment (1, 1, 0)-(1, 1, 2) in these four adjacent units forms an octahedron as illustrated in FIG. 6(b). Since all of the triangles constituting this octahedron surface have a side length of √2, the octahedron illustrated in FIG. 6(b) is a regular octahedron, which is congruent to that illustrated in FIG. 5. Regular octahedrons similar to the octahedron illustrated in FIG. 6(b) can be assumed for all of the bottom triangles in the eight regular tetrahedrons considered in FIG. 3.

As in the foregoing, the space of one face-centered cubic lattice illustrated in FIG. 2 is seen to be completely filled with eight regular tetrahedrons, six regular octahedrons illustrated in FIG. 5 and shared with the adjacent unit, and eight regular octahedrons illustrated in FIG. 6(b). Since the regular octahedrons illustrated in FIGS. 5 and 6(b) are congruent as mentioned above, dividing each of these 14 regular octahedrons into tetrahedrons determines the relationship between the face-centered cube and the tetrahedrons.

While a method for dividing a regular octahedron into tetrahedrons is not unique, an example thereof may divide the octahedron into four congruent tetrahedrons using only the vertexes of the original regular octahedrons without adding new vertexes. There are three ways of the method depending on differences in direction among ridges of tetrahedrons (sides of triangles constituting tetrahedrons) newly added by dividing.

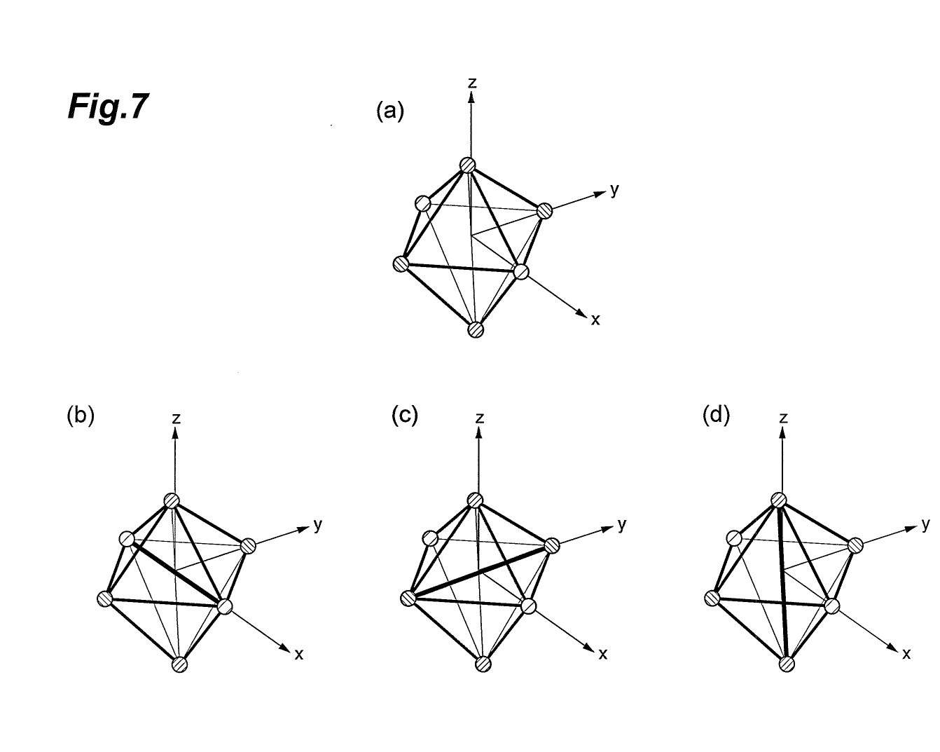

For convenience, as illustrated in FIG. 7(a), the center of gravity of the regular octahedron is placed at the origin, and three pairs of opposing vertexes are arranged on the x, y, and z axes, respectively. Then, as illustrated in FIGS. 7(b) to 7(d), three ways of the dividing method are seen to exist so as to correspond to the respective cases where sides to be added for dividing the regular octahedron are taken on the x, y, and z axes. As a result, each of them can divide one regular octahedron into four congruent tetrahedrons each constituted by two isosceles right triangles and two equilateral triangles as illustrated in FIGS. 7(b) to 7(d).

The three ways of dividing method explained with reference to FIG. 7 can be determined depending on nothing but the positions of vertexes of the regular octahedron. Therefore, for example, one of the three ways of dividing method explained with reference to FIG. 7 may be chosen at an equal probability by a random number. This allows the three kinds of dividing method to appear equally in a global mesh as a whole, thereby securing an isotropy in tetrahedralization.

Among the regular octahedrons surrounding one face-centered cubic lattice basic unit, one regular octahedron illustrated in FIG. 5 is shared between two units. This pattern exists for adjacent units on surfaces in six directions of the face-centered cube, whereby one regular octahedron is divided into four tetrahedrons by one of the methods in FIG. 7. Hence, 4×6/2=12 tetrahedrons having the pattern of FIG. 5 are generated for one unit. On the other hand, one regular octahedron illustrated in FIG. 6(b) is shared by eight adjacent units. This pattern exists for adjacent units at the vertexes in eight directions of the face-centered cube, whereby one regular octahedron is divided into four tetrahedrons by one of the methods in FIG. 7. Hence, 4×8/8=4 tetrahedrons having the pattern of FIG. 6(b) are generated for one unit.

As can be seen from the foregoing explanation, the space of one face-centered cubic basic unit illustrated in FIG. 2 is divided into 8 regular tetrahedrons and 12+4=16 tetrahedrons each composed of 2 isosceles right triangles and 2 equilateral triangles.

Growing the above-mentioned face-centered cubic lattice generates a deformable body model. First, for n deformable bodies (microparticles, referred to as MP, here), seeds of MP (seed particles, referred to as SP, here) are generated in a predetermined three-dimensional space region. Here, n is a preset number of deformable bodies. The n set of uniform random numbers giving the three-dimensional coordinates (x, y, z) are used when MPs are assumed to be arranged randomly, whereas the n coordinate values (e.g., endpoints of MPs or positions of centers of gravity of MPs) corresponding to preset positions are provided when the MPs are assumed to be located at such positions.

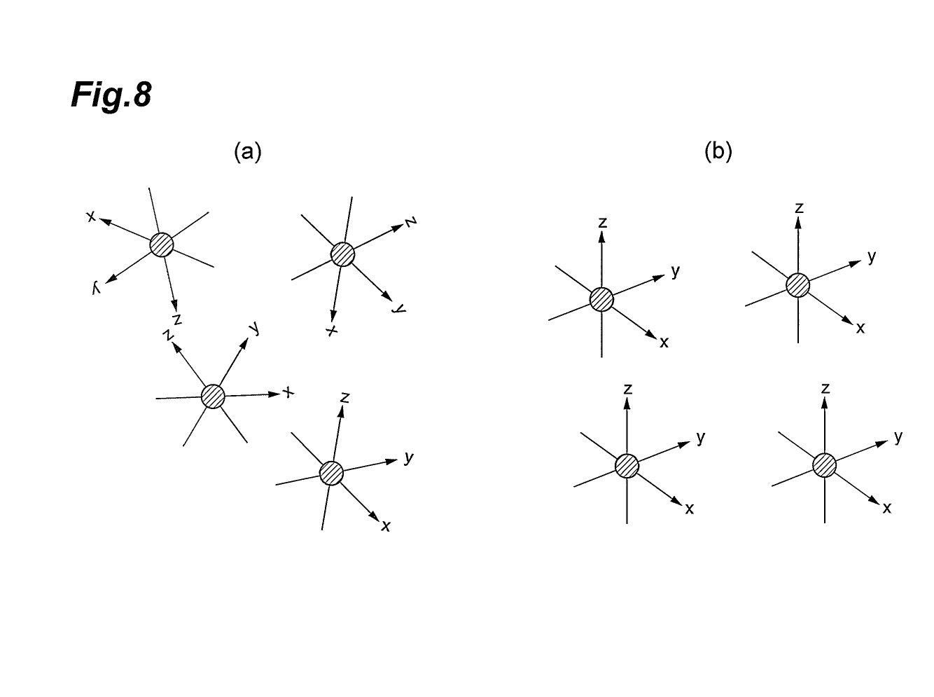

Next, directions of the face-centered cubic lattice (=MP growth directions) are given for the n SPs. Here, the n sets of coordinate transformation matrices determined from rotational angles (θx, θy, θz) of three coordinate axes given by random numbers are used when randomness is assumed in the MP growth directions, whereas n predetermined coordinate transformation matrices preset according to preset MP growth directions are used when such growth directions are assumed. FIGS. 8(a) and 8(b) illustrate examples where the MP growth directions are random and regular, respectively.

When the SP arrangement and MP growth method are determined, the MPs are grown (particles constituting the deformable bodies are newly arranged) in the following manner:

(1) Selection of MPs to grow: The MPs to grow are determined according to integer random numbers or a predetermined rule set beforehand. For example, a uniquely specifiable number (information) is set for each MP, and the number of MP to grow is determined.
(2) Selection of lattice points to grow: Assuming a face-centered cubic lattice for one MP having the origin at the SP and coordinate axes set in the MP growth directions, growth particles (referred to as GP) are sequentially arranged at adjacent face-centered cubic lattice points from the SP. When there are a plurality of GPs including the SP in one MP, the GPs to grow are determined by integer random numbers or a predetermined rule set beforehand. For example, a uniquely specifiable number (information) is set for each of SP and MPs, and the numbers of SP and MPs to grow are determined.
(3) Selection of growth directions: Since one lattice point has 12 adjacent lattice points, growth directions for one of the 12 points are determined by random numbers or a predetermined rule set beforehand. Here, among the 12 adjacent lattice points, those already having the GP arranged therewith are excluded from options. When all of the 12 adjacent lattice points of a given lattice point are occupied by the GPs, this lattice point is considered saturated, and saturation flag SF=1, so as to terminate the growth for the lattice point.
(4) Growth competition between MPs: If a growth direction of a GP of an MP is selected by the procedure of (1) to (3) mentioned above, this growth direction is considered to have the GP of another MP, and no growth will be allowed in this direction if an overlap with this GP occurs. The storage unit prestores information about the size of virtual particles (e.g., information about the radius of particles) included in the deformable body, and the model generation unit 12 determines the overlap between the GPs (particles) with reference to this information.
(5) MP growth limit: When a given MP is provided with a specific form, if the GP grown by the procedure of (1) to (4) mentioned above projects out of this form, no growth will be allowed in this direction. The storage unit 11 prestores information indicating the form of the MP, and the model generation unit 12 performs the above-mentioned determination with reference to this information.
(6) MP growth termination: In the case where the number of MP growths is limited, when all the MPs have reached the number of growths or when the SF has become 1 for all the MPs, the MP growth is terminated as the set termination condition is satisfied. The storage unit 11 prestores information concerning the set termination condition (e.g., number of growths), and the model generation unit 12 performs the above-mentioned determination with reference to this information.

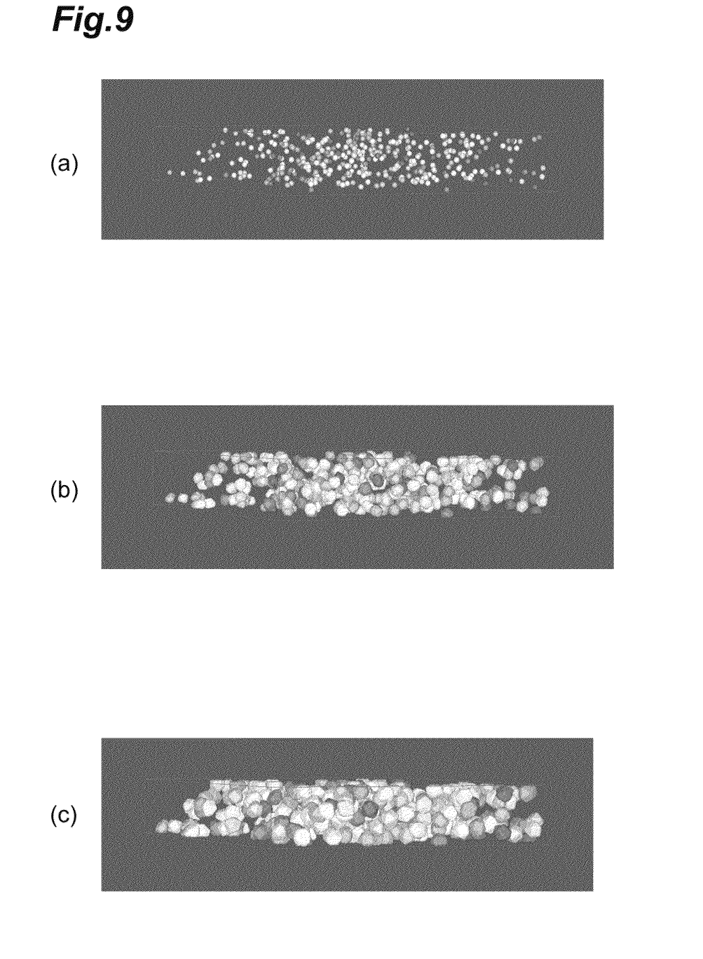

FIG. 9 illustrates how MPs grow when all of the SP coordinates, SP growth directions, growth MP selection, growth lattice selection, and growth direction selection are given to a predetermined region (rectangular parallelepiped region) by random numbers, and the growth is terminated at a predetermined growth number. The MN gradually grow from the state illustrated in FIG. 9(a) to that illustrated in FIG. 9(c). Performing the above-mentioned procedure for constructing the tetrahedrons from the information of the GPs arranged on the face-centered cubic lattice for each of the MPs determined by the foregoing process can generate automatically tetrahedralized models for a number of MPs. The size of one unit is preset according to the size of deformable bodies, the purpose of analysis, and the like. Information about the generated model may be represented on the display of the analysis apparatus 10 as illustrated in FIG. 9.

The model generation unit 12 stores information of the generated model into the storage unit 11, so as to be utilized in a later analysis. Specific examples of the model information include three-dimensional coordinates of virtual particles associated with the deformable bodies to be analyzed and information about sides of tetrahedrons to be constructed by the particles (information about which particles construct a side therebetween). Among the virtual particles, those located on the surface of the deformable bodies are provided with a flag and the like so that they can be determined as those located on the surface. The model generating function achieved with the model generation unit 12 as a main structure may also be constructed as a model generation apparatus independent from the analysis in accordance with the embodiment of the present invention and the like.

The following information is also prestored in the storage unit 11 as information used for the analysis. The following physical properties are given to the MP tetrahedral mesh (deformable bodies). While a case where each MP is assumed to be an elastic body is illustrated here, the model can be extended to structural relationships (viscoelasticity, elasto-plasticity, and the like) other than the elastic body.

Density (of deformable bodies): ρ

Elastic constants: (Young's modulus E, Poisson's ratio ν)

Damping factor: ηₜ

As parameters concerning interactions between MP surfaces, the following are given. Assuming that the interactions between the MP surfaces are handled as in the typical discrete element method as will be explained later, the spring constant and coefficient of restitution in a normal direction, spring constant and coefficient of restitution in a tangential direction, and coefficient of friction when the particles constituting the MP surfaces collide against each other are employed as input values.

Interparticle normal spring constant: Kₙ

Interparticle normal restitution coefficient: eₙ

Interparticle tangential spring constant: Kₜ

Interparticle tangential restitution coefficient: eₜ

Interparticle friction coefficient: μ

As parameters concerning interactions between boundaries of the MP and wall surfaces, the following are given. The wall surface is an object (other than the deformable bodies) against which the deformable bodies can collide. Assuming that the interactions between the boundaries of the MP and wall surfaces are handled as in the typical discrete element method, the spring constant and coefficient of restitution in a normal direction, spring constant and coefficient of restitution in a tangential direction, and coefficient of friction when the particles constituting the MP surfaces collide against the wall surface are employed as input values.

Particle—wall surface boundary normal spring constant: Kₙ_{_{—}}_{wall}

Particle—wall surface boundary normal restitution coefficient: eₙ_{_{—}}_{wall}

Particle—wall surface boundary tangential spring constant: Kₜ_{_{—}}_{wall}

Particle—wall surface boundary tangential restitution coefficient: eₜ_{_{—}}_{wall}

Particle—wall surface boundary friction coefficient: μ_{—}_{^{wall}}

The contact determination between the MP surfaces and between the boundaries of the MP and wall surfaces is performed by comparing the center distance of virtual particles arranged on different MP surfaces and the particle size with each other. Hence, the radius of the virtual particle on the MP surface is given as a parameter required for the contact determination. As the radius of the virtual particle, the one used for determination at the time of the above-mentioned MP growth can be employed.

Virtual particle radius: r_{—}_{^{v}}

As a parameter concerning a time increment in numerical integration, the following is given. The time increment Δt of the numerical integration is given as a parameter required for calculating forces carried by (the virtual particles centered at) the vertexes of tetrahedrons dividing the deformable bodies, integrating numerically according to the masses distributed to the vertexes and updating the positions of the vertexes as will be explained later. Here, Δt may be a fixed value from the start to end of calculation, but can be a variable value when large forces are expected to occur at tetrahedron vertexes dramatically in a short time as in the case of treating an analysis of a phenomenon accompanying an impact force.

Numerical integration time increment: Δt

As parameters concerning indication of the region to be calculated, the following are given. As will be explained later, a contact candidate search for surface virtual particles is performed for conducting contact determination between the MP surfaces. Cell splitting of a space is necessary for this search, whereby its range is required to be specified beforehand.

Minimum and maximum values in the x direction in the calculation region: xmin, xmax

Maximum and minimum values in the y direction in the calculation region: ymin, ymax

Maximum and minimum values in the z direction in the calculation region: zmin, zmax

Gravity and external forces and other conditions such as fixed and moving boundaries are given as inputs.

The first force calculation unit 13 is a first force calculation means for calculating a first force occurring between the virtual particles nonadjacent to each other provided on the surfaces of the deformable bodies in the model generated by the model generation unit 12. Specifically, the first force calculation unit 13 calculates the first force according to the positions of particles and preset parameters of the particles. Examples of the preset parameters of the particles include the radius, mass, and spring constant of particles as mentioned above.

The first force calculated by the first force calculation unit 13 is a force concerning the collision and contact between the deformable bodies. The first force calculation unit 13 calculates the particle interaction force for the virtual particles provided on the surface of deformable bodies. Specifically, the first force is calculated by a method used in the discrete element method or molecular dynamics method as follows, for example.

To begin with, the first force calculation unit 13 divides a three-dimensional region which is a calculation region into a plurality of cells. Information indicating the sizes of the calculation region and cells, which is prestored in the storage unit 11, is referred to. For example, the region widths in the x, y, and z directions and the cell widths in the x, y, and z directions are stored in the storage units 11. Subsequently, according to the three-dimensional coordinates of a virtual particle, the first force calculation unit 13 determines which cell contains the virtual particle. Then, it creates a contact candidate list in which particles located within a predetermined interparticle distance (e.g., particle size×1.1) among those contained in the same cell as with the target particle (the particle for which contact target particles are searched) and its adjacent cells are listed as contact candidates. Here, the contact candidate list is a list writing side by side all the particle numbers of pairs each composed of two particle numbers regarded as contact candidates. It is determined for the particles regarded as contact candidates in the contact candidate list whether they are in contact with each other or not according to the three-dimensional coordinates of the virtual particle and its radius. Here, whether the particles adjacent to each other in the same deformable body (the particles provided at both ends of the same side in the tetrahedron) are in contact with each other or not is not determined (they are excluded from the contact candidate list). Even in the same deformable body, it is determined whether the particles nonadjacent to each other (the particles not provided at both ends of the same side in the tetrahedron) are in contact with each other or not.

For the particles determined to be in contact with each other, the contact force occurring in the particles in contact is calculated according to parameters such as the above-mentioned spring constant, restitution coefficient, and friction coefficient, and the first force occurring in the individual particles is computed according to the contact force. As for the contact force, contact forces in the normal and tangential directions (Fₙ and Fₜ) are calculated by the following expressions:

Fₙ=ηₙvₙ+Kₙxₙ (1)

Fₜ=min[ηₜvₜ+Kₜxₜ,μ|Fₙ|nₜ] (2)

where x and v are a relative displacement and a relative velocity vector, respectively, min is a function indicating a value having a smaller absolute value, nₜ is a tangential unit vector, η is the viscous damping coefficient of a dashpot, which is related to the restitution coefficient e as represented by the following expression:

$$\begin{matrix}[ Math . 2 ] & \\ η = - \frac{2 ln e}{\sqrt{{π}^{2} + {ln}^{2} e}} \sqrt{{m}_{p} K} & ( 3 )\end{matrix}$$

where mₚ is the mass of the particle. The contact force may further include adhesion force, electrostatic force, van der Waals' force, and the like. The first force is expressed by a vector, for example. The first force calculation unit 13 computes the first force for each analysis time (moment) (each moment when the analysis time (moment) advances by the numerical integration time increment Δt). The first force calculation unit 13 outputs information indicating the first force calculated for each particle provided on the surface of the deformable body to the particle position updating unit 15.

The contact candidate list may not be created at all the moments in the analysis but only when a preset contact candidate update condition is satisfied. Examples of the contact candidate list update condition include a lapse of a set number of moments and that the migration length of the particle after creating the contact candidate list has surpassed a set threshold.

The first force calculation unit 13 may compute not only the contact between particles, but also forces occurring between the virtual particle provided on the deformable body and the wall surface, resistance forces received from fluids, forces received from electromagnetic fields, and the like. Surface tensions may be calculated when the deformable body is a fluid. Since the first force can be calculated by the discrete element method for the particles provided on the surface of the deformable body as mentioned above, techniques concerning the discrete element method may be employed for computing the first force as appropriate.

The second force calculation unit 14 is a second force calculation means for computing a stress occurring in the tetrahedron dividing the deformable body in the model generated by the model generation unit 12 and determining a plane dividing the tetrahedron, so as to calculate a second force occurring in each of the particles constituting the tetrahedron from the computed stress. Specifically, the second force calculation unit 14 calculates the stress occurring in the tetrahedron according to the temporal positional change or velocity of each of the particles constituting the tetrahedron.

The second force calculated by the second force calculation unit 14 is a force concerning a deformation of the deformable body. As mentioned above, the second force is calculated by the unit of a tetrahedron dividing the deformable body. The deformation of the deformable body may include destruction. For example, when particles constituting a tetrahedron have a predetermined length or greater therebetween (the neighborhood relationship between the particles is lost), the tetrahedron can be considered destroyed. When a destruction occurs, the virtual particles not provided on the surface of the deformable body (but located within the deformable body) may be treated as particles provided on the surface of the deformable body, or virtual particles may newly be arranged so as to produce a new tetrahedron (an inner part of the deformable body is assumed to be exposed by the destruction).

In this embodiment, the method for calculating the second force is referred to as QDEM (Quadraple Discrete Element Method). The QDEM is a technique using a model of interactions among four bodies (four virtual particles). The constitutive law and destruction criteria are three-dimensional. They are consistent with macro constitutive laws of actual three-dimensional materials.

As mentioned above, the model used in the QDEM is constituted by a tetrahedron whose vertexes are centers of four virtual particles which centers are sufficiently close to each other. The QDEM determines one stress occurring in the tetrahedron from interactions among the four particles. When the deformable body is a solid, the stress occurring in the deformable body is a stress generated in order for the deformed tetrahedron to resume its original form. This is elasticity. This embodiment assumes the deformable body to be an elastic body when it is a solid. When the stress occurring in the tetrahedron can be computed, the deformable body may also be assumed to be one other than the elastic body. The elastic body is a material whose stress tensor T(t) is determined by the deformation gradient tensor F(t) at the present moment alone. In this case, the stress occurring in the tetrahedron can be expressed by the elastic stress tensor T.

The elastic stress tensor T concerning the tetrahedron can be computed as follows. First, the deformation gradient tensor F is defined as:

dx=F·dX.

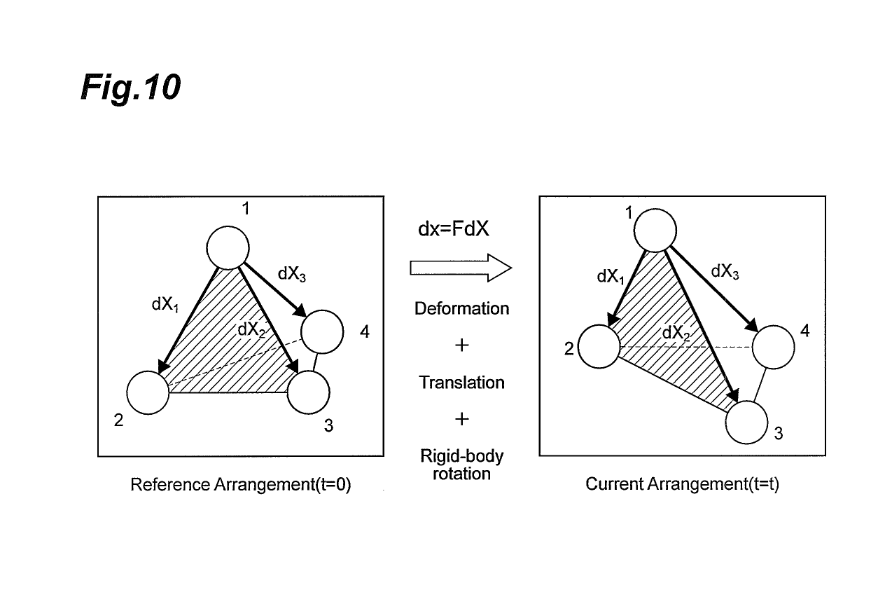

Here, dx is a matrix constituted by vectors from coordinates of a specific vertex of the tetrahedron to coordinates of other three vertexes in the current arrangement as illustrated in FIG. 10. On the other hand, dX is a matrix constituted by vectors from coordinates of a specific vertex of the tetrahedron to coordinates of other three vertexes in a reference arrangement at a moment before that of the current arrangement. When the tetrahedron is very small, the transformation from dX to dx is linear transformation. For determining nine components of F, the transformation of three sets of linearly independent vectors may be studied. Three sets of linearly independent vectors can be computed from the coordinates of four vertexes of the tetrahedron as mentioned above. The time interval between the reference arrangement and the current arrangement is the above-mentioned numerical integration time increment Δt. The current arrangement after Δt from the reference arrangement is computed by the particle position updating unit 15 according to the reference arrangement as will be explained later.

The second force calculation unit 14 calculates the deformation gradient tensor F of each tetrahedron according to the above-mentioned expression from the reference arrangement and the current arrangement. Subsequently, the second force calculation unit 14 determines the following Left Cauchy-Green deformation tensor B:

B=F·F^{T}.

When F is subjected to left polar decomposition, F=V·R. Here, V and R indicate the net deformation and the rigid-body rotation, respectively. Therefore, B=V·R·R^{T}·V=V², which is a convenient value unsusceptible to the rigid-body rotation.

A constitutive equation of an isotropic elastic body indicating the relationship from B to T is represented as follows:

T=φ₀(I_{B},II_{B},III_{B})I+φ₁(I_{B},II_{B},III_{B})B+φ₂(I_{B},II_{B},III_{B})B²

where I_{B}, II_{B}, and III_{B} are three invariants of the tensor B. I is a unit matrix. The formula is deformed by using the Clayley-Hamilton theorem, so that T is given by the following expression:

T=(φ₀−φ₂II_{B})I+(φ₁+φ₂I_{B})B+(φ₂)III_{B}⁻¹

where φ₀, φ₁, and φ₂ are input parameters for a preset material constant. Since none of minute deformations and minute strains is assumed, it is applicable until the verge of destruction. The second force calculation unit 14 calculates the elastic stress tensor T concerning the tetrahedron by using the above-mentioned expression.

In the case where the deformable body is a viscoelastic solid or a fluid, on the other hand, the stress occurring in the deformable body is a stress generated by exchange of momentums when there is a velocity gradient within the tetrahedron. This is viscosity. In this case, the stress occurring in the tetrahedron can be expressed by the viscous stress tensor T. The viscous stress tensor T concerning the tetrahedron can be calculated in the following manner. First, the velocity gradient tensor L is defined as:

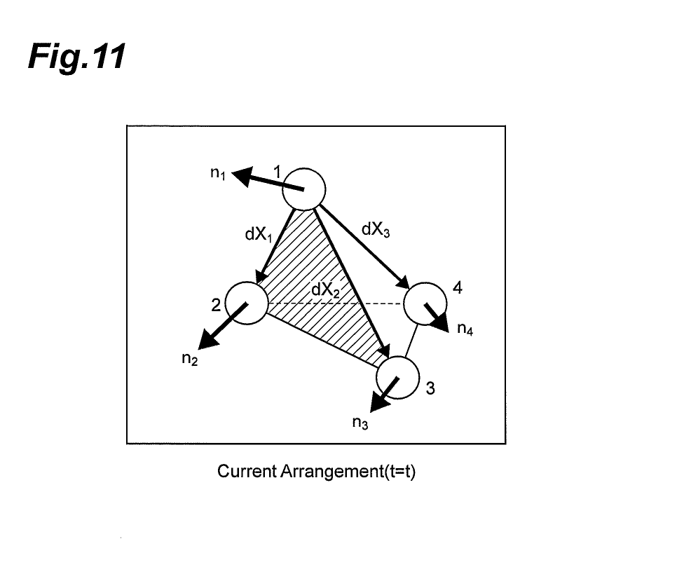

dv=L·dx

where dv is a matrix constituted by three relative velocity vectors (dvₐ=v2−v1, dv_{b}=v3−v1, dv_{c}=v4−v1) obtained when subtracting a velocity vector v1 at a specific vertex of the tetrahedron in the current arrangement from velocity vectors v2, v3, v4 at other three vertexes as illustrated in FIG. 11. When the tetrahedron is very small, the transformation from dx to dv is linear transformation. For determining nine components of L, the transformation of three sets of linearly independent vectors may be studied. The three sets of linearly independent vectors can be calculated from the coordinates of four vertexes of the tetrahedron and the relative velocity as mentioned above. The velocity vector at the specific vertex of the tetrahedron in the current arrangement is computed by the particle position updating unit 15 as will be explained later.

The second force calculation unit 14 calculates the velocity gradient tensor L for each tetrahedron according to the above-mentioned expression from the reference arrangement and current arrangement. The velocity gradient tensor L can be additively decomposed as:

L=D+W

D=½(L+L^{T})strain velocity tensor,

W=½(L−L^{T})rotation velocity tensor.

From a representation theorem, a constitutive equation indicating the relationship from D to T is represented by:

T=(−p+φ₀)I+φ₁D+φ₂D²

where p is a pressure term, which is determined from a pressure increment δp obtained by multiplying a preset coefficient of volume compressibility by the tetrahedron volume change ratio J=detF and a preset initial pressure p0. Here, φ₀, φ₁, and φ₂ are input parameters of a preset material constant (coefficient of viscosity). The second force calculation unit 14 calculates the elastic stress tensor T concerning the tetrahedron by using the above-mentioned expression.

The second force calculation unit 14 distributes thus determined stress (tensor) to particles centered at four vertexes of each tetrahedron of each deformable body, so as to calculate the second force occurring in each particle. Specifically, it divides the tetrahedron into four equal-volume blocks and computes the normal vectors and areas of the divided surfaces. First, the coordinates of the center of gravity of each side of the tetrahedron (which is the center of gravity of two points and thus is referred to as a two-point gravity center) are computed. Since the tetrahedron has six sides, there are six gravity centers. Subsequently, the coordinates of the center of gravity of each surface of the tetrahedron (which is the center of gravity of three points and thus is referred to as three-point gravity center) are computed. Since the tetrahedron has four surfaces, there are four gravity centers. Then, the coordinates of the center of gravity of the tetrahedron (which is the center of gravity of four points and thus is referred to as four-point gravity center) are computed.

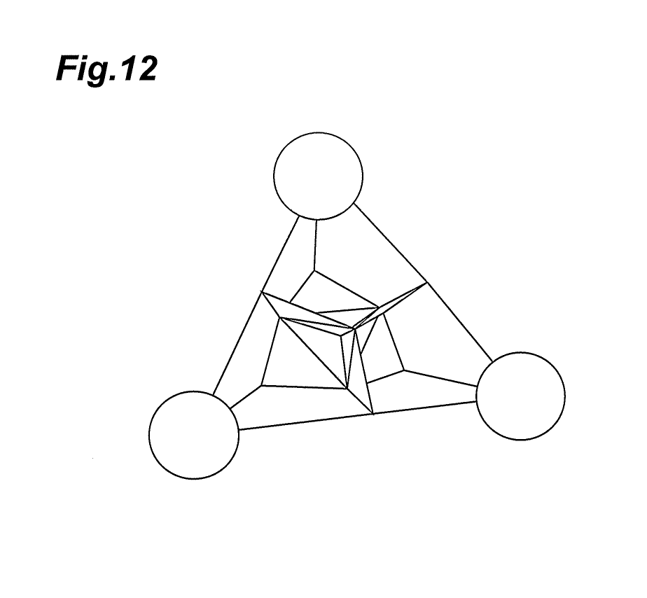

There are six triangles (4C2) each constituted by the four-point gravity center and two three-point gravity centers selected from the four three-point gravity centers. There are also six triangles (6C1) each constituted by a two-point gravity center and three-point gravity centers of two surfaces including this two-point gravity center. When cut with these 12 triangles, the tetrahedron can be divided into 4 equal-volume blocks as illustrated in FIG. 12.

The force fi applied to one particle i is determined from the stress tensor T (elastic stress tensor T or viscous stress tensor T) of the tetrahedron and the triangles dividing the tetrahedron into four blocks. The second force calculation unit 14 calculates the unit normal vector n and area dS of each of all the triangles dividing the tetrahedron into four blocks. From the stress tensor T and unit normal vector n of the tetrahedron, the second force calculation unit 14 calculates the stress vector tn on a minute cross section (a triangle dividing the tetrahedron into four blocks) within the tetrahedron according to the following expression:

tn=T^{T}·n.

When the area of the minute cross section is dS, the second force calculation unit 14 calculates the force df acting on the surface according to the following expression:

df=tndS.

The force fi applied to one particle i is:

fi=Σdf.

Here, Σ means adding the forces received from all the tetrahedrons including a vertex formed by the particle i. The second force calculation unit 14 calculates the force applied to the individual particles according to the above-mentioned expression.

As mentioned above, from the physical quantity and position of each vertex of the tetrahedron, the second force calculation unit 14 calculates its gradient tensor. Here, the gradient tensor is a deformation gradient tensor for the elastic stress, and a velocity gradient tensor for the viscous stress. The second force calculation unit 14 calculates a stress occurring in the tetrahedron by using a constitutive equation which is a tensor value function in which the calculated gradient tensor is an independent variable. From the stress tensor and the normal vector of a plane of a triangle dividing the inside of the tetrahedron, the second force calculation unit 14 calculates a stress vector occurring in the plane of the triangle. From the calculated stress vector and the area of the plane of the triangle, the second force calculation unit 14 calculates the second force occurring in each of the particles constituting the tetrahedron.

The second force is expressed by a vector, for example. The second force calculation unit 14 computes the second force for each analysis time (moment) (each moment when the analysis time (moment) advances by the numerical integration time increment Δt). The second force calculation unit 14 outputs information indicating the second force calculated for each particle provided on the surface of the deformable body to the particle position updating unit 15.

The particle position updating unit 15 is a particle position updating means for taking a sum of the first force calculated by the first force calculation unit 13 and the second force calculated by the second force calculation unit 14 for each particle of the deformable body, so as to compute a force occurring in each particle, and solving a motion equation according to the computed force, so as to update a position of each particle. Specifically, according to the force occurring in each particle computed by taking the sum of the first and second forces, it numerically integrates a motion equation of the particle (f=ma, where f is the force applied to each particle, m is the mass of the particle, and a is the velocity of the particle), so as to update the positional coordinates and velocity of the particle at the moment advanced by the numerical integration time increment Δt. At this time, a physical quantity such as the mass of the particle (which may be calculated from the density) prestored in the storage unit 11 is referred to. Since the first force is calculated for the particles on the surface of the deformable body alone, the sum is taken for only the particles on the deformable body. Only the second force is taken into consideration for the particles other than those on the surface of the deformable body.

The particle position may also be calculated assuming that not only the first and second forces but also preset gravity and external forces are applied to the particle. The calculated positional coordinates and velocity of the particle are stored in the storage unit 11 as the positional coordinates and velocity of the particle at the next moment (the moment advanced by the numerical integration time increment Δt) and used for the calculation at the next moment.

The particle position updating unit 15 also determines whether an analysis termination condition is satisfied or not and terminates the analysis if it is determined that the condition is satisfied. Examples of the termination condition include that the calculation is performed by a preset number of moments and that the positional coordinates of the particle are converged. The termination condition is prestored in the storage unit 11 and referred to by the particle position updating unit 15.

The output unit 16 is a means for outputting the results of analysis by the analysis apparatus 10. For example, the output unit 16 outputs information indicating the position and velocity of the particle, i.e., information indicating the state of the deformable body, at each moment calculated by the particle position updating unit 15 and stored in the storage unit 11. The output is performed by representing the results of the analysis onto the display of the analysis apparatus 10 so as to be recognizable by its user. Alternatively, information about the analysis results may be outputted to other devices. The foregoing is the structure of the analysis apparatus 10.

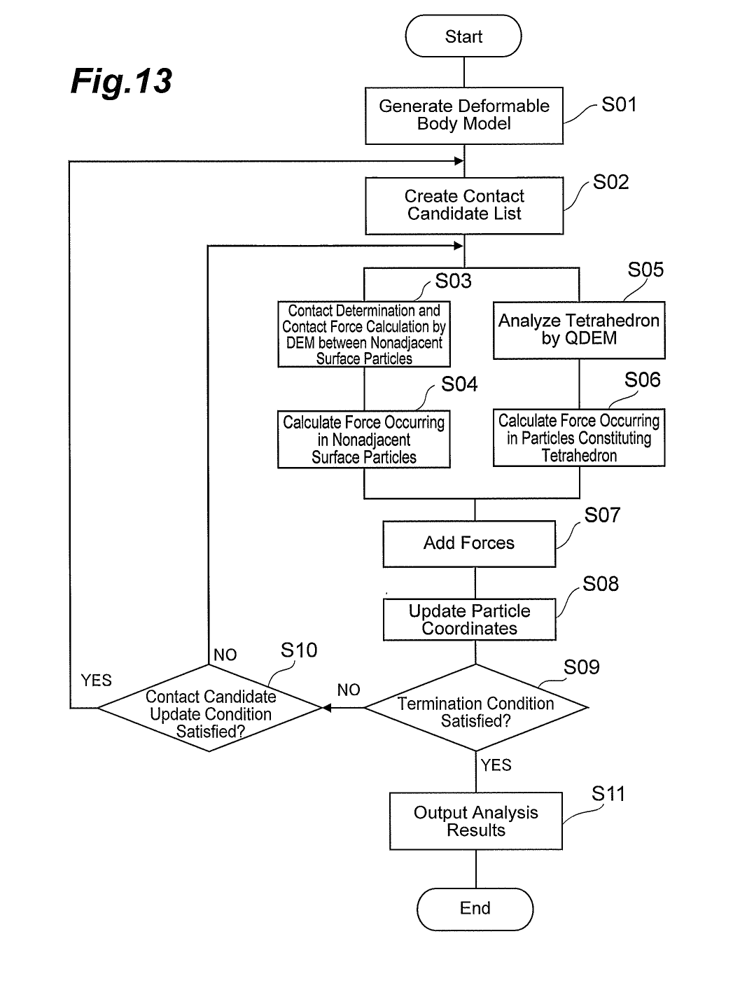

A process (analysis method) executed by the analysis apparatus 10 in accordance with this embodiment will now be explained with reference to FIG. 13. This process begins when the user of the analysis apparatus 10 performs an operation for the analysis apparatus 10 to start the analysis.

In the analysis apparatus 10, the model generation unit 12 generates a model of a deformable body to be analyzed as mentioned above (S01: model generation step). This model is one in which a deformable body having a three-dimensional form is provided with a plurality of virtual particles whose centers constitute vertexes of a tetrahedron dividing the deformable body. Information of the generated model is stored in the storage unit 11 and is referred to by the individual constituents (first force calculation unit 13, second force calculation unit 14, particle position updating unit 15, and output unit 16) when necessary.

Next, the first force calculation unit 13 generates a contact candidate list for the particles provided on a surface of the deformable body for which the first force is calculated in the model generated by the model generation unit 12 (S02: first force calculation step). Here, the particles adjacent to each other (the particles serving as both ends of sides of the tetrahedron) do not become contact candidates. Subsequently, the first force calculation unit 13 determines whether the particles regarded as contact candidates in the contact candidate list are in contact with each other or not and calculates the contact force between the particles in contact with each other (S03: first force calculation step). Then, the first force calculation unit 13 calculates the first force occurring in the individual particles according to the contact force (S04: first force calculation step). Information indicating the calculated first force is outputted from the first force calculation unit 13 to the particle position updating unit 15.

On the other hand, after the processing at S02, the second force calculation unit 14 calculates by the QDEM the stress occurring in the tetrahedron dividing the deformable body in the model generated by the model generation unit 12 according to the temporal positional change or velocity of each of the particles constituting the tetrahedron (S05: second force calculation step). Subsequently, the second force calculation unit 14 determines a plane dividing the tetrahedron and, from the stress produced in the tetrahedron while using this plane, calculates the second force occurring in the individual particles (S06: second force calculation step). Information indicating the calculated second force is outputted from the second force calculation unit 14 to the particle position updating unit 15. The above-mentioned processing of S03 and S04 and that of S05 and S06, which are performed in parallel, are not always required to be done so but may be performed sequentially one by one, for example.

After the first and second forces are calculated, the particle position updating unit 15 adds the first and second forces together for each particle (S07: particle position updating step). Subsequently, the particle position updating unit 15 numerically integrates the motion equation of the particles according to the added forces, so as to calculate and update the positional coordinates and velocity of each particle at the next moment (the moment advanced by the numerical integration time increment Δt) (S08: particle position updating step).

Next, the particle position updating unit 15 determines whether an analysis termination condition is satisfied or not. Examples of the termination condition include the upper limit for the analysis time (simulation time) and the lower limit for changes in coordinates of particles. When it is determined that the analysis termination condition is not satisfied (NO at S09), the analysis continues as follows. To begin with, the first force calculation unit 13 determines whether a contact candidate update condition is satisfied or not (S10). When it is determined that the contact candidate update condition is satisfied (YES at S10), the first force calculation unit 13 subsequently generates a contact candidate list again for the particles provided on the surface of the deformable body (S02). The contact candidate list is produced according to the (newest) positional coordinates of the particles updated at S08.

When it is determined that the contact candidate update condition is not satisfied at S10 (NO at S10) or when the contact candidate list is generated again at S02, the above-mentioned processing of S03 and S05 and thereafter are subsequently repeated. Here, the first and second forces are calculated according to the (newest) positional coordinates of the particles updated at S08.

When it is determined that the analysis termination condition is satisfied at S09 (YES at S09), the output unit 16 outputs results of the analysis, thereby terminating the process (S11: output step). The output of the analysis results is not necessarily be performed only at the end of process, but may also be done by outputting information indicating the positional coordinates and velocity of each particle after each processing operation of S08, for example. Information indicating the positional coordinates and velocity of each particle may be stored into the storage unit 11 simultaneously with the output at S11. The foregoing is the process (analysis method) executed by the analysis apparatus in accordance with this embodiment.

In this embodiment, as explained in the foregoing, the first force concerning collisions and contacts between deformable bodies is calculated by a method such as the discrete element method, the second force concerning deformations of the deformable bodies is calculated by the QDEM, and the position of each particle is updated according to a force of their sum. Virtual particles provided in the deformable bodies are used for the calculation of each of the first and second forces. Therefore, this embodiment can compute both of the first and second forces by calculations for a common item constituted by the above-mentioned virtual particles. Hence, as compared with a conventional method which calculates deformations of a deformable body and collisions between deformable bodies by separate processes, this embodiment handles complicated contact determination and contact force calculation between deformable bodies as a contact problem between virtual surface particles arranged at vertexes of a tetrahedral mesh on the surface of deformable bodies and thus can perform them at a high speed by the discrete element method or the like and further can calculate the amount of deformations of deformable bodies and the force generated by the deformations from information owned by virtual particles which are vertexes of the tetrahedral mesh such as their coordinates and velocity and the like, while the force is processed as a force applied to the common virtual particles used when calculating the contact force between the deformable bodies. Therefore, it can process not only the collisions and contacts between the deformable bodies but also the deformations of the deformable bodies themselves by calculating the motion of common virtual particles alone, so that the exchange of information between the calculation of a force caused by a deformation of a deformable body and the calculation of the contact force between deformable bodies as seen in a conventional technique combining FEM and DEM is less, while the processing for distributing the contact force between the deformable bodies to vertexes of deformable bodies is unnecessary, whereby the analysis can be performed at a high speed under a low calculation load by taking account of not only the collisions and contacts between the deformable bodies but also the deformations of the deformable bodies themselves even when there are a large number of deformable bodies. When this technique is performed by parallel computing with a parallel computer, it is totally unnecessary to create a huge matrix for the whole subject region such as a global stiffness matrix of deformable bodies used for calculating the FEM, as compared with the conventional one combining the FEM and DEM, whereby the technique is advantageous for high-speed calculations in that there is no need for all inter-node communications in parallel computing at all.

Growing the above-mentioned particles to produce a deformable body model can efficiently generate a model provided with a regular, high-quality tetrahedron for a number of deformable bodies. Specifically, when there are a large number of deformable bodies, the above-mentioned method using polygons takes a long calculation time for providing the deformable bodies with a tetrahedral mesh in conformity to the forms of deformable bodies, whereas the particle growing method in accordance with this embodiment can more efficiently generate a tetrahedron dividing the deformable bodies than the method using polygons does. However, it is not always necessary to generate a deformable body model by growing particles when the tetrahedron can be generated efficiently by using polygons, for example.

As parameters of a particle used for the analysis, the radius, mass, and spring constant of the particle can be used as mentioned above. This configuration makes it possible to calculate the first force appropriately and securely.

An example in which the analysis apparatus 10 (analysis method) in accordance with this embodiment actually performed an analysis will now be illustrated. This example is an analysis in which a mattress placed in the air at a height of 0.5 m from a fixed floor surface and a ball made of the same material as with the mattress are dropped at the same time. This analysis can simultaneously study deformations and restitution characteristics of the mattress caused by the collision between the mattress and the floor and the collision between the ball and the mattress.

In this example, values of parameters were given as follows: density: ρ=2000.0; elastic modulus: (Young's modulus E, Poisson's ratio ν)=1.0×10⁷, 0.25, damping factor: ηₜ=0.001; interparticle normal spring constant: Kₙ=1.0×10⁶; interparticle normal restitution coefficient: eₙ=0.8; interparticle tangential spring constant: Kₜ=1.6×10⁶; interparticle tangential restitution coefficient: eₜ=0.8; interparticle friction coefficient: μ=0.6; particle-wall surface boundary normal spring constant: Kₙ_{_{—}}_{wall}=1.0×10⁶; particle-wall surface boundary normal restitution coefficient: eₙ_{_{—}}_{wall}=0.8; particle-wall surface boundary tangential spring constant: Kₜ_{_{—}}_{wall}=1.0×10⁶; particle-wall surface boundary tangential restitution coefficient: eₜ_{_{—}}_{wall}=0.8; particle-wall surface boundary friction coefficient: μ_{_{—}}_{wall}=0.6; virtual particle radius: r_{—}_{^{v}}=0.01; numerical integration time increment: Δt=1.0×10⁻⁵; minimum and maximum values in the x direction in the calculation region: xmin, xmax=0.0, 5.0; minimum and maximum values in the y direction in the calculation region: ymin, ymax=0.0, 5.0; minimum and maximum values in the z direction in the calculation region: zmin, zmax=0.0, 5.0; gravitational acceleration=9.8.

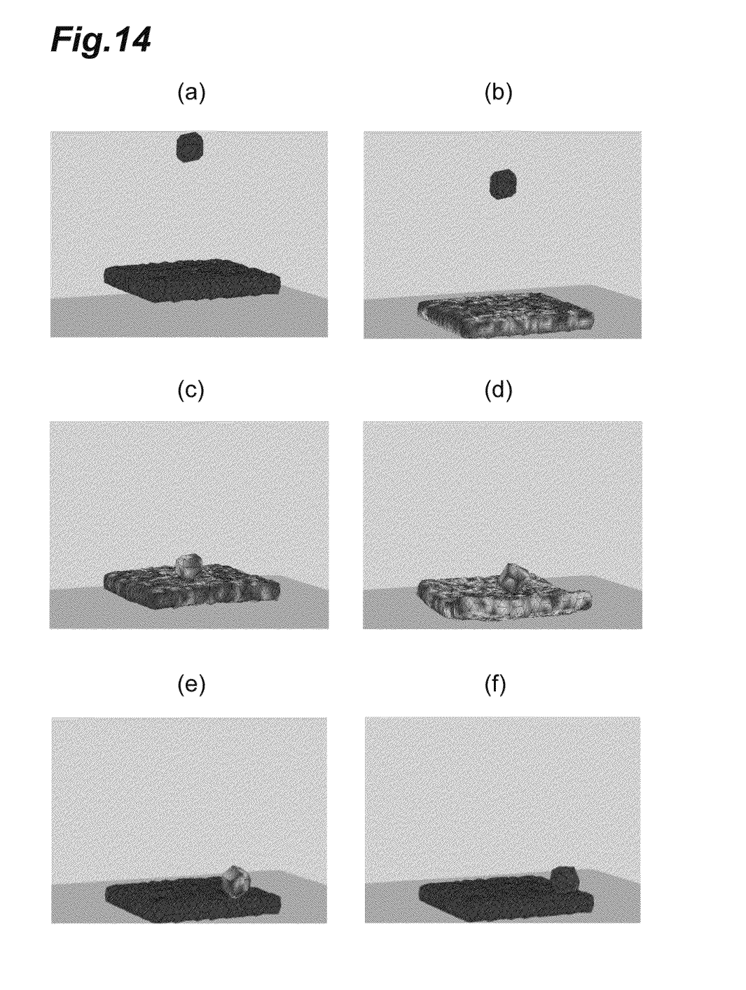

FIG. 14(a) illustrates an initial state. The gradation in the drawing indicates absolute values of strains occurring in tetrahedrons. FIG. 14(b) illustrates a state where the mattress and the floor surface collided with each other. FIG. 14(c) illustrates a state where the rising mattress and the ball collided with each other for the first time. FIG. 14(d) illustrates a state where the mattress and the ball collided with each other for the second time. FIG. 14(e) illustrates a state where the mattress and the ball collided with each other for the third or later time, whereby the ball was rolling. FIG. 14(f) illustrates the final state. As this example illustrates, the analysis apparatus 10 (analysis method) achieves an analysis taking account of collisions between deformable bodies and deformations of the deformable bodies. Information indicating the results of analysis generated as illustrated in FIG. 14 may also be represented on a display in the analysis apparatus 10.

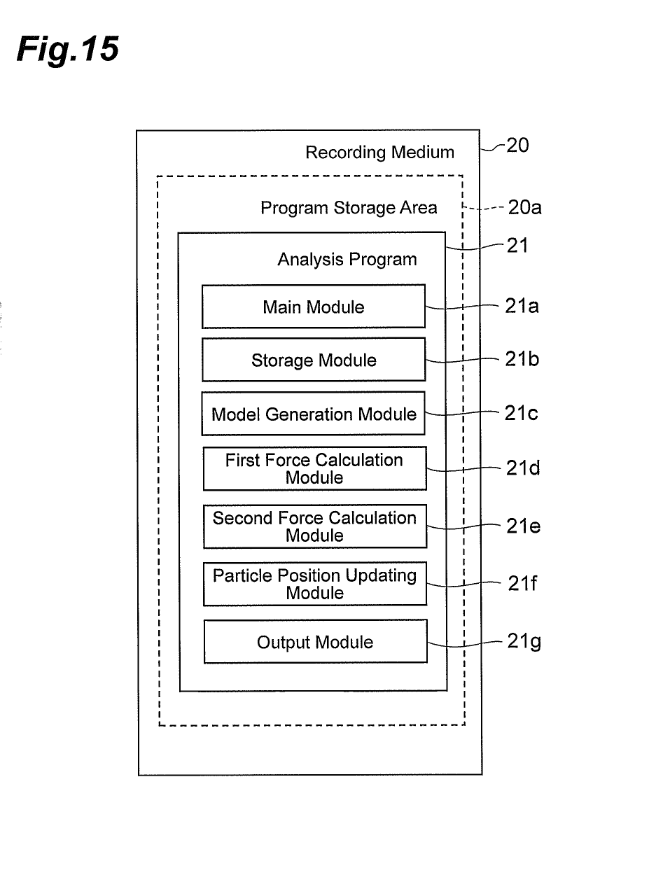

An analysis program for causing a computer to execute a process for analyzing a motion of at least one deformable body in a series of analysis apparatuss 10 mentioned above will now be explained. As illustrated in FIG. 15, an analysis program 21 is stored in a program storage area 20a formed in a recording medium 20 which is inserted into the computer so as to be accessed thereby or with which the computer is equipped.

The analysis program 21 comprises a main module 21a for totally controlling the analysis process, a storage module 21b, a model generation module 21c, a first force calculation module 21d, a second force calculation module 21e, a particle position updating module 21f, and an output module 21g. Functions achieved by executing the storage module 21b, model generation module 21c, first force calculation module 21d, second force calculation module 21e, particle position updating module 21f, and output module 21g are similar to those of the storage unit 11, model generation unit 12, first force calculation unit 13, second force calculation unit 14, particle position updating unit 15, and output unit 16 of the above-mentioned analysis apparatus 10, respectively.

A part or whole of the analysis program 21 may be transmitted through a transmission medium such as a communication line, so as to be received and recorded (e.g., installed) by other devices. The individual modules of the analysis program 21 may be installed in any of a plurality of computers instead of a single computer. In this case, a computer system constructed by the plurality of computers performs a process for analyzing the motion of at least one deformable body in the series of analysis program 21 mentioned above. The analysis program 21 may also be stored in a server connected to a network and downloaded to a predetermined hardware device.

### INDUSTRIAL APPLICABILITY

The analysis (simulation) method of the present invention is expected to be applicable to motion analyses of deformable polygonal elements in disaster-related simulations such as landslides and destructions of building structures in the field of civil engineering, analyses of transportation and burden descent behaviors of iron ore and coke in the field of chemical engineering, designing of construction machines, robotics, and development of space infrastructures in the field of mechanical engineering, evaluation of durability of submarine cables and communication cables in the field of ocean engineering, evaluation of behaviors of capsules at the time of packing and their durability in the field of pharmaceutical industry, transportation and packing of granular bodies (e.g., rice and confectionery) in the field of food processing, and the like.

### REFERENCE SIGNS LIST

10 . . . analysis apparatus; 11 . . . storage unit; 12 . . . model generation unit; 13 . . . first force calculation unit; 14 . . . second force calculation unit; 15 . . . particle position updating unit; 16 . . . output unit; 20 . . . recording medium; 20a . . . program storage area; 21 . . . analysis program; 21a . . . main module; 21b . . . storage module; 21c . . . model generation module; 21d . . . first force calculation module; 21e . . . second force calculation module; 21f . . . particle position updating module; 21g . . . output module

1. An analysis apparatus for analyzing a motion of at least one deformable body, the apparatus comprising:
model generation means for generating a model of the deformable body provided with a plurality of virtual particles whose centers constitute vertexes of a tetrahedron dividing the deformable body;
first force calculation means for calculating a first force occurring between the particles nonadjacent to each other provided on a surface of the deformable body in the model generated by the model generation means;
second force calculation means for computing a stress occurring in the tetrahedron dividing the deformable body in the model generated by the model generation means and determining a plane dividing the tetrahedron, so as to calculate a second force occurring in each of the particles constituting the tetrahedron from the computed stress; and
particle position updating means for taking a sum of the first force calculated by the first force calculation means and the second force calculated by the second force calculation means for each particle, so as to compute a force occurring in each particle, and solving a motion equation according to the computed force, so as to update a position of each particle.

2. An analysis apparatus according to claim 1, wherein the model generation means generates the model of the deformable body by further arranging particles constituting the vertexes of the tetrahedron while in a preset positional relationship with the particles arranged according to the number of deformable bodies until a set termination condition is satisfied.

3. An analysis apparatus according to claim 1, wherein the first force calculation means calculates the first force according to the position of each particle and a preset parameter of the particle.

4. An analysis apparatus according to claim 3, wherein the preset parameter comprises the radius, mass, and spring constant of the particle.

5. An analysis apparatus according to claim 1, wherein the second force calculation means calculates the stress occurring in the tetrahedron dividing the deformable body according to a temporal positional change or velocity of each of the particles constituting the tetrahedron.

6. An analysis method by an analysis apparatus for analyzing a motion of at least one deformable body, the method comprising:
a model generation step of generating a model of the deformable body provided with a plurality of virtual particles whose centers constitute vertexes of a tetrahedron dividing the deformable body;
a first force calculation step of calculating a first force occurring between the particles nonadjacent to each other provided on a surface of the deformable body in the model generated at the model generation step;
a second force calculation step of computing a stress occurring in the tetrahedron dividing the deformable body in the model generated at the model generation step and determining a plane dividing the tetrahedron, so as to calculate a second force occurring in each of the particles constituting the tetrahedron from the computed stress; and
a particle position updating step of taking a sum of the first force calculated at the first force calculation step and the second force calculated at the second force calculation step for each particle, so as to compute a force occurring in each particle, and solving a motion equation according to the computed force, so as to update a position of each particle.

7. An analysis program for causing a computer to analyze a motion of at least one deformable body, the program making the computer function as:
model generation means for generating a model of the deformable body provided with a plurality of virtual particles whose centers constitute vertexes of a tetrahedron dividing the deformable body;
first force calculation means for calculating a first force occurring between the particles nonadjacent to each other provided on a surface of the deformable body in the model generated by the model generation means;
second force calculation means for computing a stress occurring in the tetrahedron dividing the deformable body in the model generated by the model generation means and determining a plane dividing the tetrahedron, so as to calculate a second force occurring in each of the particles constituting the tetrahedron from the computed stress; and
particle position updating means for taking a sum of the first force calculated by the first force calculation means and the second force calculated by the second force calculation means for each particle, so as to compute a force occurring in each particle, and solving a motion equation according to the computed force, so as to update a position of each particle.

8. A computer-readable recording medium recording an analysis program for causing a computer to analyze a motion of at least one deformable body, the program making the computer function as:
model generation means for generating a model of the deformable body provided with a plurality of virtual particles whose centers constitute vertexes of a tetrahedron dividing the deformable body;
first force calculation means for calculating a first force occurring between the particles nonadjacent to each other provided on a surface of the deformable body in the model generated by the model generation means;
second force calculation means for computing a stress occurring in the tetrahedron dividing the deformable body in the model generated by the model generation means and determining a plane dividing the tetrahedron, so as to calculate a second force occurring in each of the particles constituting the tetrahedron from the computed stress; and
particle position updating means for taking a sum of the first force calculated by the first force calculation means and the second force calculated by the second force calculation means for each particle, so as to compute a force occurring in each particle, and solving a motion equation according to the computed force, so as to update a position of each particle.
